(19) United States
(12) Patent Application Publication
(10) Pub. No.: US 2009/0183828 A1
(43) Pub. Date: Jul. 23, 2009

(54) PROCESS FOR PRODUCING GLASS PLATE PROVIDED WITH CERAMIC COLOR PRINT

(75) Inventors: Naoki OKAHATA, Chiyoda-ku (JP); Satoshi KASHIWABARA, Chiyoda-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Asahi Glass Company, Limited, Chiyoda-ku (JP)

(21) Appl. No.: 12/327,140

(22) Filed: Dec. 3, 2008

(30) Foreign Application Priority Data
Dec. 5, 2007 (JP) 2007-315014

(51) Int. Cl. B32B 37/00; B05D 3/00; B32B 38/00

(52) U.S. Cl. 156/281; 427/532

(57) ABSTRACT

It is an object of the present invention to provide a process for producing a glass plate provided with a ceramic color print, whereby a ceramic color print having a small color difference can be formed on a glass plate with good adhesion.

A process for producing a glass plate provided with a ceramic color print, wherein a ceramic color print is formed on a glass plate, which comprises a step of forming a laminate having first and second layers laminated by printing on a glass plate, and a step of baking the glass plate having the laminate formed thereon, wherein the first layer is formed by electro printing by using a first ceramic color toner, the second layer is formed by electro printing by using a second ceramic color toner, and the first ceramic color toner has a number average particle size D₅₀ which is larger than D₅₀ of the second ceramic color toner.

The present invention relates to a process for producing a glass plate provided with a ceramic color print.

A window glass of an automobile is held along its periphery by a urethane sealant from the car interior side, and a ceramic color print is provided to be interposed between the window glass and the urethane sealant. Such a ceramic color print is provided mainly on peripheral regions of a fixed window of an automobile on the car interior side, and has functions to prevent deterioration of the urethane sealant due to ultraviolet rays and to shield terminals of heating wires, etc. provided on peripheral portions of the window glass on the car interior side from being seen from the car exterior side. Further, in recent years, a ceramic color print having a pattern of fine dots formed by gradation, has been widely used for the purpose of improving the design.

Since automobiles are mass-produced, glass plates for windows to be used for automobiles are usually also mass-produced. For this purpose, as a process for forming a ceramic color print on a glass plate, a process is known wherein an inorganic pigment paste comprising fine inorganic pigment particles and glass frit in a resin solution is printed on a glass plate by screen printing, and then the glass plate is baked to decompose the resin and at the same time to fix the fine inorganic pigment particles on the glass plate by the glass frit. It is thereby possible to carry out printing sequentially on a large number of glass plates by means of a screen printing plate with a predetermined pattern.

However, in the case of a window glass for automobiles, the shape of the glass plate, the pattern of a ceramic color print, etc. vary depending upon the models of automobiles. Accordingly, it is required to stock screen printing plates depending upon the models of automobiles.

Further, an inorganic pigment paste is used for the screen printing, and when the solvent in the coated film formed on a glass plate is to be volatilized, the solvent remaining in the vicinity of the surface of the coating film tends to be readily volatilized. Accordingly, such a screen printing method has a problem that the solvent remaining in the vicinity of the glass plate in the coated film tends to be hardly volatilized. As a result, volatilization of the solvent tends to be non-uniform in the thickness direction of the coated film, thus leading to a problem such that the adhesion between the ceramic color print and the glass plate tends to be inadequate.

Further, the color of the ceramic color print is also important as viewed from the side opposite to the side on which the ceramic color print is formed on a glass plate. Specifically, there may be a case where even if the adhesion between the ceramic color print and the glass plate is good, the difference (the color difference) between the color of the obtained ceramic color print and the desired color is substantial. Such a color difference tends to remarkably increase in a case where a thick ceramic color print having a thickness of at least bout 10 μm is to be formed.

Therefore, Patent Document 1 discloses a ceramic color ink-baked glass plate having, on a glass plate surface, a baked layer of a ceramic color ink constituted by two layers i.e. a base print film layer and an overcoating print film layer formed thereon. Here, the base print film layer has sufficient adhesion to the glass plate and to the overcoating print film layer and has a function to provide a desired color when the base print film layer is seen through the glass plate.

Further, the overcoating print film layer has a function to improve the forming die releasability of a glass plate from a forming die at the time of bending and forming the glass plate by the forming die. Further, when a ceramic color ink-baked glass plate is to be produced, a ceramic color ink for a base print film layer is printed on a glass plate surface and preliminarily dried at a temperature of from 100 to 250° C. Then, a ceramic color ink for an overcoating print film is printed on the glass plate surface and preliminarily dried at a temperature of from 100 to 250° C. Thus, it is possible to volatilize the solvent uniformly in the thickness direction of the coating film, and consequently, it is possible to obtain a thick ceramic color print having a small color difference and a sufficient adhesion to the glass plate. However, it is necessary to carry out a process of volatilizing the solvent twice. Therefore, a process is desired which requires no step of volatilizing the solvent.

On the other hand, Patent Document 2 discloses a transfer sheet in which a toner comprising a colorant, a binder and glass frit as the main components, is used, and a colored toner image is formed on a transfer sheet for ceramics after baking by an electrophotographic process.

Here, the transfer sheet for ceramics has at least one water-soluble layer and at least one resin film layer having a thickness of at least 1 μm sequentially laminated on a substrate.

It is further disclosed that a toner image layer and a resin coating film of the transfer sheet are peeled from the support member, then the resin coating film side is brought in close contact with a heat resistant solid surface, and the resin coating film and the toner image layer are bonded to the heat resistant solid surface.

Further, a method for baking the toner image on the heat resistant solid surface is disclosed wherein the heat resistant solid having the toner image layer and the resin coating film is heated to a temperature of at least the resin coating film-ashing temperature.

However, there is a problem such that the transfer rate of the toner image layer tends to be low in addition to a drawback that the process tends to be complex.

Further, there is also a problem that the adhesion between the toner image layer and the heat resistant solid tends to be inadequate.

Furthermore, there is also a problem that it is difficult to form a thick toner image layer on the heat resistant solid, whereby the color difference tends to be large.

Patent Document 1: JP-A-63-265843

Patent Document 2: JP-A-2000-214624

In view of the above mentioned problems in the prior art, it is an object of the present invention to provide a process for producing a glass plate provided with a ceramic color print, whereby a ceramic color print having a small color difference can be formed on a glass plate with good adhesion.

Namely, the present invention provides the following:

1. A process for producing a glass plate provided with a ceramic color print, wherein a ceramic color print is formed on a glass plate, which comprises a step of forming a laminate having first and second layers laminated by printing on a glass plate, and a step of baking the glass plate having the laminate formed thereon, wherein the first layer is formed by electro printing by using a first ceramic color toner, the second layer is formed by electro printing by using a second ceramic color toner, and the first ceramic color toner has a number average particle size D₅₀ which is larger than D₅₀ of the second ceramic color toner.
2. The process for producing a glass plate provided with a ceramic color print according to the above 1, wherein D₅₀ of the first ceramic color toner is from 10 to 50 μm, and D₅₀ of the second ceramic color toner is from 5 to 20 μm.
3. The process for producing a glass plate provided with a ceramic color print according to the above 1 or 2, wherein the first layer has a layer thickness of from 20 to 80 μm, and the second layer thickness of from 5 to 40 μM.
4. The process for producing a glass plate provided with a ceramic color print according to any one of the above 1 to 3, wherein the first and second layers are laminated sequentially from the glass plate side.
5. The process for producing a glass plate provided with a ceramic color print according to the above 4, wherein the second ceramic color toner contains glass frit having crystallizability.
6. The process for producing a glass plate provided with a ceramic color print according to any one of the above 1 to 3, wherein the second and first layers are laminated sequentially from the glass plate side.
7. The process for producing a glass plate provided with a ceramic color print according to the above 6, wherein the first ceramic color toner contains glass frit having crystallizability.
8. The process for producing a glass plate provided with a ceramic color print according to the above 5 or 7, wherein crystals are precipitated in the glass frit by heating at a predetermined temperature.
9. The process for producing a glass plate provided with a ceramic color print according to any one of the above 1 to 8, which comprises a first step of forming on a photoreceptor a laminate having the first and second layers laminated by printing in an inverse order to the laminate to be formed on the glass plate, and a second step of transferring the laminate formed on the photoreceptor onto the glass plate.
10. The process for producing a glass plate provided with a ceramic color print according to any one of the above 1 to 8, which comprises a first step of forming on an intermediate transfer member a laminate having the first and second layers laminated by printing in an inverse order to the laminate to be formed on the glass plate, and a second step of transferring the laminate formed on the intermediate transfer member onto the glass plate, wherein the first step comprises a step of forming the first layer on a photoreceptor, a step of transferring the first layer formed on the photoreceptor onto the intermediate transfer member, a step of forming the second layer on a photoreceptor, and a step of transferring the second layer formed on the photoreceptor onto the intermediate transfer member.

In this specification, “electro printing” means printing by a xerography system. Here, printing by a xerography system is basically such that a photoconductor drum is electrified, followed by exposure to form an electrostatic latent image, then the electrostatic latent image is developed with a toner to form a toner image, and further, the toner image is transferred to a transfer receptor.

According to the present invention, it is possible to provide a process for producing a glass plate provided with a ceramic color print, whereby a ceramic color print having a small color difference can be formed on a glass plate with good adhesion.

In the accompanying drawings:

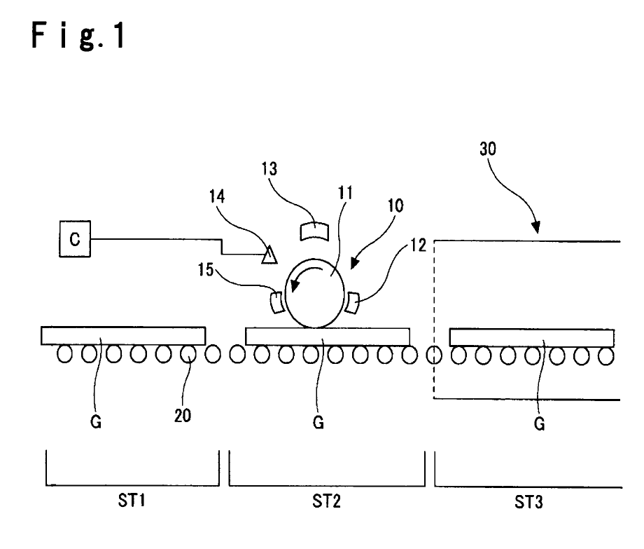

FIG. 1 a view illustrating an example of an apparatus for producing a glass plate provided with a ceramic color print to be used in the present invention.

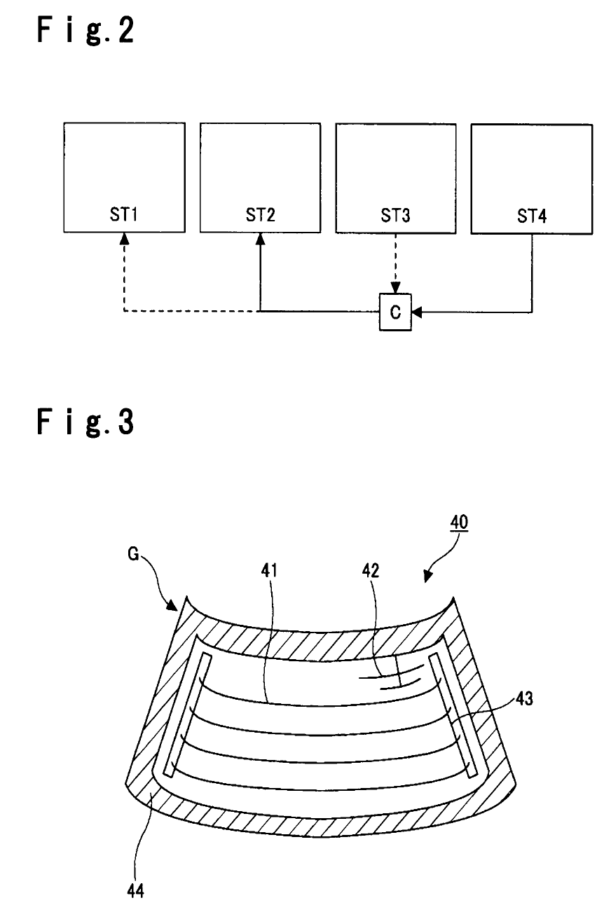

FIG. 2 is a chart illustrating an example of a control process to be used in the present invention.

FIG. 3 is a view illustrating an example of a glass plate provided with a ceramic color print for a rear window glass of an automobile.

Now, the best mode for carrying out the present invention will be described with reference to the drawings.

The process for producing a glass plate provided is with a ceramic color print of the present invention, will be described with reference to an apparatus for producing a glass plate provided with a ceramic color print, as shown in FIG. 1.

Firstly, in ST1, a glass plate G is cut into a predetermined shape, followed by chamfering and then by cleaning.

Then, by using carrier rolls 20, the glass plate G is carried to a position to face an electro printing apparatus 10. Then, at ST2, by means of an electro printing apparatus 10, a ceramic color toner image having a predetermined pattern is formed on the surface of the glass plate G.

Further, by using the carrier rolls 20, the glass plate G is carried into a heating furnace 30.

Then, in ST3, the glass plate G having a ceramic color toner image formed, is heated to a predetermined temperature to obtain a glass plate provided with a ceramic color print.

In FIG. 1, as a photoreceptor, a photoconductor drum 11 is employed, but a photoconductor belt or the like may be used.

Now, ST1 to ST3 will be described in detail.

In ST1, firstly, a rectangular glass plate G is cut into a predetermined shape, and the cut surfaces are chamfered.

Then, the glass plate G is cleaned, and if necessary, preheated.

In ST2, a destaticizer 12 is used to remove electric charges from the surface of the photoconductor drum 11, while rotating the photoconductor drum 11. Thereafter, by means of an electrification apparatus 13, the surface of the photoconductor drum 11 is electrified, and by means of a light source 14, exposure light is applied to the surface of the photoconductor drum 11 to form an electrostatic latent image of a predetermined pattern on the surface of the photoconductor drum 11.

Then, by means of a developer 15, a ceramic color toner is supplied to the surface of the photoconductor drum 11 to form a ceramic color toner image of a predetermined pattern on the surface of the photoconductor drum 11.

Further, by employing a transfer method such as the after-mentioned (A), (B) or (C), the ceramic color toner image formed on the surface of the photoconductor drum 11 is transferred to the surface of a glass plate G, to form a ceramic color toner image of a predetermined pattern on the surface of the glass plate G.

At that time, between the photoconductor drum 11 and the glass plate G, an intermediate transfer member such as an intermediate transfer belt may be interposed, so that the ceramic color toner image formed on the photoconductor drum 11 may firstly be transferred to the intermediate transfer member and then transferred to the is glass plate G.

In a computer C, data for forming an electrostatic latent image of a predetermined pattern on the photoconductor drum 11 by applying exposure light to the photoconductor drum 11, are stored. By command signals from the computer C, exposure light of a predetermined pattern will be applied from the light source 14.

Further, in a case where the glass plate provided with a ceramic color print is used for a window glass of an automobile, the shape of the glass plate G, the pattern of the electrostatic latent image, etc., vary depending upon the model of the automobile. Therefore, such data are preferably stored and accumulated in the computer C.

Thus, it becomes easy to change the command signals from the computer C depending upon the model of the automobile. As a result, it becomes possible to easily change from the production of a glass plate provided with a ceramic color print of a certain type to the production of a glass plate provided with a ceramic color print of another type.

In ST3, the glass plate G is heated to a predetermined temperature to bake the ceramic color toner image.

The ceramic color toner image is thereby baked to the glass plate G and converted to ceramic, whereby a ceramic color print of a predetermined pattern is formed on the surface of the glass plate G.

Usually, a window glass of an automobile is curved. Therefore, in a case where a glass plate provided with a ceramic color print is used for a window glass of an automobile, the glass plate G is thermally processed at a predetermined temperature. Namely, it is heated to a predetermined temperature, followed by bending processing for reinforcing treatment. Here, in a case where the glass plate G is a laminated glass, annealing treatment is carried out instead of such reinforcing treatment.

Now, the above mentioned transfer methods (A) to (C) will be described.

(A) On the surface of the photoconductor drum 11, a ceramic color toner image (laminate) having the first and second layers laminated, is formed, and then, the ceramic color toner image (laminate) is transferred to the surface of the glass plate G. By this method, the ceramic color toner image (laminate) can be transferred from the photoconductor drum 11 to the glass plate G by just one operation, and therefore, this method is excellent in working efficiency and precision in positioning.

Further, it is also possible to form the ceramic color toner image (laminate) on the surface of the photoconductor drum 11 by just one operation by using two developers, whereby the production efficiency can be improved.

Further, by just one operation, it is possible to thermally transfer the ceramic color toner image (laminate) on the glass plate, whereby it is possible to suppress deterioration of the thermoplastic resin of the first layer of the ceramic color toner image. As a result, the adhesion between the first layer and the second layer is excellent, whereby a dense ceramic color print will be formed.

(B) On the surface of an intermediate transfer member interposed between the photoconductor drum 11 and the glass plate G, a ceramic color toner image (laminate) having the first and second layers laminated, is formed, and then, the ceramic color toner image (laminate) is transferred to the surface of the glass plate G.

By this method, the ceramic color toner image (laminate) can be transferred from the intermediate transfer member to the glass plate G by just one operation. Thus, this method is excellent in working efficiency or precision in positioning.

Further, by two operations, the first and second layers are respectively formed on the surface of the photoconductor drum 11, whereby the pattern can effectively be controlled, and clear first and second layers can be formed.

Further, by just one operation, the ceramic color toner image (laminate) is thermally transferred, whereby it is possible to suppress deterioration of the thermoplastic resin of the first layer of the ceramic color toner image. As a result, the adhesion between the first and second layers is excellent, whereby a dense ceramic color print can be formed.

(C) On the surface of a glass plate G, a ceramic color toner image (laminate) having the first and second layers laminated, is directly formed.

In this method, the ceramic color toner image (single layer body) is transferred, whereby a change of the pattern by transferring tends to scarcely take place, and a ceramic color print having desired shielding performance and color will be easily formed.

Further, by two operations, the ceramic color toner image (single layer body) is formed on the surface of the photoconductor drum 11, whereby a pattern can be effectively controlled, and a clear ceramic color toner image (single layer body) can be formed.

Further, a process of forming and thermally transferring the ceramic color toner image (single layer body) on the surface of the glass plate G, is repeated twice. Therefore, the ceramic color toner image (single layer body) of the first layer will be sufficiently heated. As a result, the leveling performance at the interface between the glass plate G and the ceramic color print will be remarkable improved. Further, the ceramic color toner image (single layer body) of the second layer is made of a material excellent in affinity with the ceramic color toner image (single layer body) of the first layer thermally transferred on the glass plate, whereby the transferring efficiency can be improved. As a result, the adhesion between the glass plate G and the baked ceramic color print of the first layer and ceramic color print of the second layer can be maintained to be good.

Here, in (A) and (B), on the surface of each of the photoconductor drum 11 and the intermediate transfer member, the ceramic color toner image (laminate) is laminated in an order inverse to the laminated order of the ceramic toner image (laminate) after transferred on the surface of the glass plate G.

Further, the first layer is formed by electro printing by using a first ceramic color toner.

On the other hand, the second layer is formed by electro printing by using a second ceramic color toner.

In the present invention, the number average particle size D₅₀ of the first ceramic color toner is larger than D₅₀ of the second ceramic color toner. It is thereby possible that even if the shielding property or color of the first layer is inadequate, the portion deficient in the shielding property or color may be complemented by the second ceramic color toner to provide the desired shielding property or color.

D₅₀ of the first ceramic color toner is preferably from 10 to 50 μm, particularly preferably larger than 20 μm and at most 35 μm. It is thereby possible to impart the desired shielding property or color to the ceramic color print. When D₅₀ is at least 10 μm, the desired shielding property and color can easily be developed. On the other hand, when D₅₀ is at most 50 μm, it is possible to prevent disturbance of the image due to an image defect (hereinafter referred to as fogging) caused by scattering of the toner to a non-image portion, whereby an image clear to its edge portion tends to be readily obtainable.

Further, D₅₀ of the second ceramic color toner is preferably from 5 to 20 μm, particularly preferably larger than 5 μm and at most 15 μm. It is thereby possible that even if the shielding property or color, of the first layer is inadequate, the portion deficient in the shielding property or color may be complemented by the second ceramic color toner having a small diameter to provide the desired shielding property or color.

When D₅₀ is at least 5 μm, the desired shielding property and color tends to be readily developed. On the other hand, when D₅₀ is at most 20 μm, it is possible to prevent disturbance of an image due to fogging, and an image clear to its edge portion tends to be readily obtainable.

Here, D₅₀ may be measured by a known method, and, for example, it may be measured by means of a particle image analyzing apparatus of flow type, laser diffraction/scattering type or dynamic light scattering type. In the present invention, it is preferred to measure D₅₀ by means of a flow type particle image analyzing apparatus, since the presence or absence of agglomerated particles can be accurately measured, and the shape of particles can be measured at the same time as D₅₀.

At that time, the thickness of the first layer is preferably from 20 to 80 μm, more preferably from 20 to 60 μm. It is thereby possible to impart the desired shielding property or color to the ceramic color print.

When the thickness of the first layer is at least 20 μm, the desired shielding performance and color tends to be readily developed. On the other hand, when the thickness of the first layer is at most 80 μm, it is possible to prevent such failure in removal of the binder as the layer thickness of the ceramic color print tends to be too thick.

Further, the thickness of the second layer is preferably from 5 to 40 μm, more preferably from 5 to 20 μm. It is thereby possible to develop the desired shielding property or color and at the same time to suppress turbulence of the image due to fogging.

When the thickness of the second layer is at least 5 μm, it is possible that even if the shielding property or color of the first layer is inadequate, the portion deficient in the shielding property or color may be complemented by the second ceramic color toner having a small particle size, whereby the desired shielding property or color can be developed. On the other hand, when the thickness of a second layer is at most 40 μm, it is possible to prevent such failure in removal of the binder as the thickness of the ceramic color print tends to be too thick.

Here, in the case of a laminate wherein the first and second layers are adjacently laminated, the thickness of the laminate is preferably from 25 to 70 μm. It is thereby possible to form a thick ceramic color print which is capable of imparting the desired shielding property or color.

When the thickness of the laminate is at least 25 μm, the desired shielding property and color can easily be obtained. On the other hand, when the thickness of the laminate is at most 70 μm, it is possible to prevent turbulence of the image due to fogging, whereby a clear image can easily be obtained. Further, it is possible to prevent failure in removal of the binder which may result if the ceramic color print is too thick.

In the laminate, the first layer may be formed on the glass plate G side, or the second layer may be formed on the glass plate G side.

In a case where the first layer is formed on the glass plate G side, non-uniformity in the shielding property or color which is caused by the particle size of the first ceramic color toner being large, is effectively complemented by the second ceramic color toner having a small size, whereby the desired shielding property or color can easily be obtained.

On the other hand, in a case where the second layer is formed on the glass plate G side, the first layer is formed on the second layer excellent in the surface smoothness, whereby the entire laminate will be excellent in the surface smoothness. As a result, a ceramic color print excellent in the shielding property can easily be formed.

The first and second ceramic color toners may be the same or different, provided that they are different in D₅₀. Now, characteristics common to the first and second ceramic color toners will be described.

A ceramic color toner preferably comprises fine inorganic pigment particles, a thermoplastic resin and glass frit. It is thereby possible to attach a ceramic color toner image to the surface of the glass plate G by the adhesiveness of the thermoplastic resin.

When such a ceramic color toner image is heated at a predetermined temperature, firstly, the thermoplastic resin is thermally decomposed and volatilized.

Then, the glass frit begins to be melted, and the ceramic color toner image will be attached to the surface of the glass plate G primarily by the adhesiveness of the glass frit. At that time, by completely thermally decomposing and volatilizing the thermoplastic resin until the glass frit is completely melted, it is possible to reduce a carbide residue in the ceramic color print.

Finally, the glass plate G is heated to a temperature exceeding 600° C., whereby fine inorganic pigment particles are sintered and bonded to one another, and spaces among the sintered fine inorganic pigment particles are embedded with the glass frit for leveling.

Thereafter, when the molten glass frit is solidified, a ceramic color print comprising bonded fine inorganic pigment particles and a glass component embedding the spaces, is formed on the surface of the glass plate G.

The ceramic color toner preferably has matrix particles comprising fine inorganic pigment particles, a thermoplastic resin and glass frit.

The ceramic color toner may be composed solely of such matrix particles or one having an external additive dispersed and deposited on the surface of the matrix particles.

The thermoplastic resin functions as a binder to form particles comprising fine inorganic pigment particles and glass frit. Further, the thermoplastic resin preferably functions as a binder which is capable of transferring a ceramic color toner image formed on the surface of the photoconductor drum 11 or the intermediate transfer member to the glass plate G, and as a binder which is capable of attaching the fine inorganic pigment particles and glass frit to the glass plate G until the glass frit is melted.

The thermoplastic resin preferably has a disappearance temperature T₁₀₀ of from 350 to 575° C., more preferably from 350 to 500° C., particularly preferably from 400 to 450° C. The adhesion between the ceramic color print and the surface of the glass plate G is thereby improved.

If T₁₀₀ is lower than 350° C., the thermoplastic resin may completely be thermally decomposed before the glass frit is melted, whereby the adhesion between the ceramic color toner image and the surface of the glass plate G is likely to be low.

On the other hand, if T₁₀₀ exceeds 575° C., at the time of baking, the thermoplastic resin will not be readily thermally decomposed, and a carbide is likely to remain in the ceramic color print. As a result, an adhesion between the ceramic color print and the surface of the glass plate G tends to be inadequate.

Further, if T₁₀₀ exceeds 575° C., until the glass frit begins to be solidified, the thermoplastic resin may not completely be thermally decomposed, and bubbles formed by the thermal decomposition and volatilization of the thermoplastic resin may remain in the ceramic color print. As a result, light is likely to be scattered in the ceramic color print, and the color of the ceramic color print is likely to be deviated from the desired color, i.e. the color difference is likely to be large. Especially, if bubbles remain at the interface with the glass plate G, the color difference tends to be large.

Here, T₁₀₀ means a temperature at which no heat generation is observed in a DTA graph of the thermoplastic resin when it is measured at a heating rate of 10° C./min from room temperature to 700° C. by means of a differential thermal analyzer (DTA).

The thermoplastic resin preferably has a melting point T_{q} of from 70 to 125° C., particularly preferably from 80 to 110° C.

If T_{q} exceeds 125° C., melting of the thermoplastic resin tends to be inadequate when the ceramic color toner image is to be transferred to the surface of the glass plate G. As a result, the leveling property of the ceramic color toner image is likely to be deteriorated, and at the time of baking, the thermoplastic resin is likely to be non-uniformly thermally decomposed. Accordingly, pinholes or cracks are likely to be formed in the ceramic color print, and the surface smoothness of the ceramic color print is likely to be deteriorated. Further, the color difference of the ceramic color print is likely to increase, whereby the shielding property is likely to be deteriorated.

On the other hand, if T_{q} is lower than 70° C., a hot offset phenomenon tends to occur when the ceramic color toner image is to be transferred to the surface of the glass plate G. It is thereby likely that the molten ceramic color toner attaches to the photoconductor drum 11 or to the intermediate transfer member, whereby a sufficient amount of the ceramic color toner image may not be transferred to the glass plate G. As a result, it tends to be difficult to form a thick ceramic color print having a uniform thickness. Further, pinholes or cracks tend to be formed in the ceramic color print, whereby the color difference of the ceramic color print is likely to increase, and the shielding property is likely to decrease.

Here, T_{q} is obtained as follows. A die having a diameter of 1.0 mm and a height of 2.0 mm is set in a flow tester, and 1 g of a thermoplastic resin is permitted to melt-flow through the die under a load of 980 N at a heating rate of 6° C./min. From the obtained flow curve, the flow terminal point and the flow starting point are obtained, and a temperature at a point of (Sₘₐₓ+Sₘᵢₙ)/2 is obtained, where Sₘₐₓ is the piston stroke at the flow terminal point, and Sₘᵢₙ is the piston stroke at the flow starting point.

The thermoplastic resin preferably has a temperature T_{η} of from 70 to 115° C., particularly preferably from 80 to 110° C., at which its viscosity becomes 10⁵ Pa·sec. The thermoplastic resin has a heat decomposable property, and its viscosity decreases as the temperature rises. Accordingly, at the time of transferring a ceramic color toner image to the glass plate G, when the viscosity of the thermoplastic resin contained in the toner is at most 10⁵ Pa·sec, the leveling property of the ceramic color toner image will be good.

Accordingly, if T_{η} exceeds 115° C., melting of the thermoplastic resin tends to be inadequate at the time of transferring the ceramic color toner image to the glass plate G, and the leveling property of the ceramic color toner image is likely to decrease. As a result, at the time of baking, the thermoplastic resin is likely to be non-uniformly thermally decomposed, whereby pinholes or cracks are likely to form in the ceramic color print, whereby the smoothness of the ceramic color print is likely to decrease.

Further, the color difference of the ceramic color print may increase, and the shielding property may decrease. On the other hand, if T_{η} is lower than 70° C., a hot offset phenomenon tends to occur at the time of transferring the ceramic color toner image to the glass plate G, whereby the molten ceramic color toner is likely to attach to the photoconductor drum 11 or to the intermediate transfer member, and a sufficient amount of the ceramic color toner image may not be transferred to the glass plate G.

As a result, it becomes difficult to form a thick ceramic color print having a uniform thickness. Further, pinholes or cracks are likely to form in the ceramic color print, whereby the color difference of the ceramic color print may increase, and the shielding property may decrease.

Here, T_{η} is a temperature at which the viscosity becomes 10⁵ Pa·sec when the temperature-viscosity characteristic curve of the thermoplastic resin is measured by using a flow tester.

The thermoplastic resin is preferably a polymer obtained by polymerizing a monomer containing at least one of styrene and its derivatives. It is thereby possible that the ceramic color toner will not undergo coagulation or the like before it is supplied to the photoconductor drum 11, and the ceramic color toner image can be well attached to the surface of the photoconductor drum 11.

Further, the ceramic color toner image formed on the surface of the photoconductor drum 11 can be well transferred and attached to the surface of the glass plate G.

Further, it is considered that at the time of baking, when such a thermoplastic resin is thermally decomposed (depolymerized), styrene and its derivatives excellent in resonance stabilization effects will be formed, and such styrene or styrene derivatives will finally disappear. It is considered that by the presence of such a stabilized reaction route, the heat decomposition property of the thermoplastic resin will be good.

The content of styrene and its derivatives in the entire monomer to be used for the preparation of the thermoplastic resin is preferably from 50 to 100 mol %, more preferably from 60 to 100 mol %.

Further, the thermoplastic resin preferably has a weight average molecular weight of from 3,000 to 150,000, particularly preferably from 5,000 to 80,000.

The glass frit may be either lead-type glass frit or non-lead-type glass frit, but from the viewpoint of environment, etc., non-lead-type bismuth-silica glass frit is preferred. Here, the bismuth-silica glass frit is meant for glass frit containing bismuth and silicon.

The glass frit preferably has a number average particle size D₅₀ of from 0.1 to 5 μm, particularly from 0.5 to 3 μm. If D₅₀ is less than 0.1 μm, the adhesion between the ceramic color print and the surface of the glass plate G may sometimes be inadequate. On the other hand, if D₅₀ exceeds 5 μm, the glass frit is likely to be exposed on the surface of the matrix particles of the ceramic color toner, and the adhesion between the ceramic color toner image and the surface of the glass plate G is likely to decrease.

The glass frit preferably has a softening point of from 500 to 600° C. If the softening point is lower than 500° C., the glass frit is likely to start melting before the thermoplastic resin starts thermal decomposition. As a result, baking failure of the ceramic color toner image i.e. accumulation failure of the fine inorganic pigment particles or adhesion failure of the ceramic color print is likely to result. On the other hand, if the softening point exceeds 600° C., the thermoplastic resin is likely to be completely decomposed and volatilized before the glass frit starts to melt. As a result, the adhesion between the ceramic color toner image and the surface of the glass plate G is likely to decrease, and the adhesion between the ceramic color print and the surface of the glass plate G is likely to be inadequate.

The glass frit includes one having a nature of precipitating crystals (hereinafter referred to as crystallizability) in the process of being further heated after being melted, and one having a nature of not precipitating crystals (hereinafter referred to as non-crystallizability). In the present invention, either one may be employed.

Here, as between the first and second layers, a layer not on the glass plate G side preferably contains glass frit having crystallizability. Thus, at the time of baking, when the glass frit is crystallized by heat processing at a predetermined temperature, the ceramic color print tends to be scarcely attached to a pressing die used at the time of press bending processing of the glass plate G. As a result, the release property can be improved.

The glass frit having crystallizability may, for example, be a glass containing lithium, zinc and silicon, which precipitates zinc silicate-lithium type crystals, a glass containing bismuth and silicon, which precipitates bismuth silicate crystals, or one preliminarily containing crystals which will be precipitated during the baking, such as zinc silicate, boron silicate, lithium silicate, zinc titanate or lithium titanate.

Here, the temperature for precipitating the crystals can be determined as the crystallizable peak temperature by a differential thermal analysis. However, the thermal processing temperature is preferably higher than the crystallizable peak temperature.

The fine inorganic pigment particles are an essential component to shield ultraviolet rays, or ultraviolet rays and visible light, and they are preferably a heat resistant pigment. As fine inorganic pigment particles to be used for forming a black ceramic color print, it is possible to employ oxides and composite oxides of metals such as Co, Cr, Mn, Fe and Cu. For example, heat resistant pigments may be mentioned such as a Cu—Cr—Mn composite oxide, a Cr—Co composite oxide, a Fe—Mn composite oxide, a Cr—Fe—Ni composite oxide, a Cr—Cu composite oxide and magnetite, which are excellent in black color development properties, and two or more of them may be used in combination.

The fine inorganic pigment particles preferably have a number average particle size D₅₀ of from 0.1 to 5 μm, particularly preferably from 0.1 to 3 μm. If D₅₀ is less than 0.1 μm, the shielding property of the ceramic color print is likely to be inadequate.

On the other hand, if D₅₀ exceeds 5 μm, an unclear ceramic color toner image is likely to be formed.

The ceramic color toner is preferably such that the matrix particles comprise from 10 to 50 wt % of fine inorganic pigment particles, from 5 to 40 wt % of a thermoplastic resin and from 40 to 85 wt % of glass frit, and particularly preferably comprise from 15 to 40 wt % of fine inorganic pigment particles, from 10 to 30 wt % of a thermoplastic resin and from 45 to 80 wt % of glass frit.

If the content of fine inorganic pigment particles is less than 10 wt %, the shielding property of the ceramic color print is likely to be inadequate. On the other hand, if the content of the fine inorganic pigment particles exceeds 50 wt %, the adhesion between the ceramic color print and the surface of the glass plate G is likely to be inadequate.

If the content of the thermoplastic resin is less than 5 wt %, the adhesion of the ceramic color toner image to the surface of the glass plate G is likely to decrease at the time of baking.

As a result, the adhesion between the surface of the glass plate G and the ceramic color print tends to be inadequate. On the other hand, if the content of the thermoplastic resin exceeds 40 wt %, a carbide is likely to remain in the ceramic color print, whereby the adhesion between the ceramic color print and the surface of the glass plate G is likely to be inadequate. Further, by thermal decomposition of the thermoplastic resin, cracks, voids, etc. are likely to form in the ceramic color print.

If the content of the glass frit is less than 40 wt %, the adhesion between the ceramic color print and the surface of the glass plate G is likely to be inadequate. On the other hand, if the content of the glass frit exceeds 85 wt %, the shielding property of the ceramic color print is likely to decrease.

The weight ratio of the glass frit to the thermoplastic resin is preferably at least 1.5, more preferably at least 2. If this weight ratio is less than 1.5, a carbide is likely to remain in the ceramic color print, and the adhesion between the ceramic color print and the surface of the glass plate G is likely to be inadequate. Further, by decomposition of the thermoplastic resin, cracks, voids, etc. are likely to from in the ceramic color print.

The weight ratio of the glass frit to the thermoplastic resin is preferably at most 10, more preferably at most 8. If this weight ratio exceeds 10, at the time of baking, the thermoplastic resin is likely to be completely thermally decomposed before the glass frit begins to melt, whereby the adhesion between the ceramic color toner image and the surface of the glass plate G is likely to decrease. As a result, the adhesion between the ceramic color print and the surface of the glass plate G is likely to be inadequate.

Further, the weight ratio of the glass frit to the fine inorganic pigment particles is preferably at least 1, more preferably at least 1.5. If this weight ratio is less than 1, it tends to be difficult to highly disperse the fine inorganic pigment particles in the ceramic color print, and at the same time the adhesion between the ceramic color print and the surface of the glass plate G is likely to be inadequate.

Further, the weight ratio of the glass frit to the fine inorganic pigment particles is preferably at most 5, more preferably at most 4. If this weight ratio exceeds 5, it tends to be difficult to form a ceramic color print having the desired color and being excellent in the shielding property.

In the ceramic color toner, the matrix particles may further contain an inorganic filler, whereby it is possible to improve the strength of the ceramic color print or to improve the release property. As such an inorganic filler, it is preferred to employ a heat resistant inorganic filler. For example, aluminum borate, α-alumina, potassium titanate, zinc oxide, magnesium oxide, magnesium borate, basic magnesium sulfate or titanium diborate may, for example, be mentioned, and two or more of them may be used in combination.

The shape of the inorganic filler is not particularly limited, but it is preferably a plate form, since it is thereby possible to improve the shielding property of the ceramic color print. Further, the total weight of the fine inorganic pigment particles and the inorganic filler is preferably from 1 to 5 to the weight of the glass frit.

Further, the matrix particles may contain a charge controlling agent such as an azo metal-containing complex, a salicylic acid metal-containing complex, a Fe-type bisazo complex, a tetraphenyl borate derivative, an aromatic hydroxycarboxylic acid derivative, an aliphatic hydroxycarboxylic acid derivative, calixarene derivative, a nigrosine complex, a triphenylmethane complex, a quaternary ammonium salt, an quaternary alkylammonium salt or a quaternary pyridinium salt.

The amount of the charge controlling agent may suitably be selected depending upon e.g. the type of the thermoplastic resin, but it is preferably at most 10 wt %, particularly preferably at most 5 wt %, to the thermoplastic resin. If the amount exceeds 10 wt %, the thermal decomposition of organic group of the charge controlling agent is likely to prevent the thermal decomposition of the thermoplastic resin. As a result, a carbide is likely to remain in the ceramic color print, or bubbles are likely to remain in the ceramic color print. Further, even in a case where a charge controlling agent made of a metal-containing complex is used, if the amount exceeds 10 wt %, at the time of thermal processing, metal ions are likely to migrate into the ceramic color toner image, whereby the color is likely to be changed.

The content of the fine inorganic pigment particles, the thermoplastic resin and the glass frit in the matrix particles is preferably from 80 to 100 wt %, particularly preferably from 90 to 100 wt %.

The ceramic color toner is obtained, for example, by mixing or kneading the thermoplastic resin, the fine inorganic pigment particles, the glass frit and, if necessary, other components to prepare pellets, and then pulverizing the pellets, followed by classification.

Here, the kneading temperature is preferably from 150 to 200° C. If the kneading temperature is lower than 150° C., components such as the thermoplastic resin, the fine inorganic pigment particles and the glass frit may not uniformly be mixed. On the other hand, if the kneading temperature exceeds 200° C., the thermoplastic resin is likely to be thermally decomposed.

Further, the baking temperature in ST3 is preferably from 600 to 740° C., particularly preferably from 600 to 700° C. If the baking temperature is lower than 600° C., the glass frit may not completely be melted, whereby the adhesion between the ceramic color print and the surface of the glass plate G is likely to be inadequate.

On the other hand, if the baking temperature exceeds 740° C., the glass plate G is likely to be deformed. In this specification, “baking” is meant for heating at a temperature of from 600 to 740° C.

Further, in ST3, in a case where the glass plate G is subjected to thermal processing, the thermal processing temperature is suitably selected depending upon the type of the thermal processing. For example, the thermal processing temperature for bending is preferably from 600 to 700° C.

The thermal processing temperature is usually higher than the temperature at which the thermoplastic resin and glass frit in the ceramic color toner melts. Accordingly, by heating to such a thermal processing temperature, the ceramic color toner image is baked to form a ceramic color print.

The glass plate G is not particularly limited, but it may, for example, be soda lime glass, alkali free glass or quartz glass.

The thickness of the ceramic color print is preferably from 5 to 50 μm, more preferably from 7 to 40 μm, particularly preferably from 10 to 30 μm.

When the thickness is at least 5 μm, a stabilized shielding property can readily be obtained, and when it is at most 50 μm, it is possible to prevent peeling of the ceramic color print or formation of cracks.

FIG. 2 shows an example of a control process to be used in the present invention. As mentioned above, on the glass plate G treated in ST1, a ceramic color toner image is formed in ST2 and heated in ST3 to form a ceramic color print, whereby a glass plate provided with the ceramic color print is obtained.

Further, in ST4, the shielding property and color of the ceramic color print are measured, and the data of the shielding property and color are transmitted to the computer C.

At that time, if necessary, also the data of the heating temperature in ST3 will also be transmitted to the computer C. In the computer C, based on the transmitted data, it is judged whether or not the desired shielding property and color are obtained.

In a case where it is judged that the desired properties are not obtained, by calculation by the computer C, the pattern of the electrostatic latent image or the feeding amount of the ceramic color toner will be adjusted to obtain the desired properties. The data of the pattern of the electrostatic latent image and the feeding amount of the ceramic color toner thus adjusted will be fed back to ST2 and will be reflected to the conditions for forming the next ceramic color toner image is on the glass plate G.

Once the desired shielding property and color are thereby obtained, it is possible to produce the glass plate provided with a ceramic color print in a large number by fixing the conditions to form the ceramic color toner image on the glass plate G.

As an index for the shielding property, the visible light transmittance may be used, and as an index for the color, the color difference ΔE may be used. The glass plate provided with a ceramic color print has a visible light transmittance of usually at most 2.5%, preferably at most 1.0%, more preferably at most 0.7%, particularly preferably at most 0.3%.

Further, the glass plate provided with a ceramic color print preferably has a color difference ΔE of at most 2.0, more preferably at most 1.2, particularly preferably at most 1.0.

Further, in a case where the glass plate provided with a ceramic color print is to be used for a window glass for an automobile, data for the pattern of an electrostatic latent image to be transmitted to ST2 from the computer C are changed depending upon the model of the automobile. It is thereby possible to easily change the production of a glass plate G of a certain model to the production of a glass plate G of another model.

FIG. 3 shows an example of a glass plate provided with a ceramic color print for a rear window glass of an automobile.

In a glass plate 40 provided with a ceramic color print, electrically conductive printed wires (defogger 41, antenna wire 42, bus bar 43) are formed at a center portion of a glass plate G, and a dark ceramic color print 44 is formed at the peripheral portion.

Here, the glass plate 40 provided with a ceramic color print is one to be mass-produced via steps of ST1 to ST4 by means of the apparatus for producing a glass plate provided with a ceramic color print, shown in FIG. 1.

### EXAMPLES

Now, the present invention will be described in further detail with reference to Examples 1 and 2 and Comparative Example 1, but it should be understood that the present invention is by no means thereby restricted. Here, “parts” means parts by weight.

### Evaluation of Binder Resin

T₁₀₀ (° C.): Using a differential thermal analyzer (TG-DTA2000SR (manufactured by Bruker AXS), measurement was carried out from room temperature to 700° C. at a heating rate of 10° C./min. Here, T₁₀₀ is the temperature in the DTA graph at which heat generation is no longer observed.

T_{fb}, T_{q} (° C.): A die of 1.0 mm in diameter×2.0 mm was set in a flow tester CFT-500 (manufactured by Shimadzu Corporation), and 1 g of a binder resin was melted and flowed through the die under conditions of a load of 980 N and a heating rate of 6° C./min to obtain a rheogram, from which the starting point and terminal point of flow were obtained. Here, T_{fb} is the temperature at the starting point of flow, and T_{q} is the temperature at a point where the piston stroke is (Sₘₐₓ+Sₘᵢₙ)/2, where Sₘₐₓ is the piston stroke at the terminal point of flow, and Sₘᵢₙ is the piston stroke at the starting point of flow.

T_{η} (° C.): Using the above flow tester, the temperature-viscosity characteristic curve of a binder resin was measured. Here, T_{η} is the temperature at which the viscosity of the molten resin becomes 10⁵ P·sec.

### Evaluation of Particles

Average particle size D₅₀: The average particle size was measured by using a flow system particle image analyzer FPIA-3000 (manufactured by Sysmex Corporation). D₅₀ is the number average value of circle-corresponding diameters.

### Evaluation of Glass Frit

Using the above differential thermal analyzer, the softening point and the crystallization peak temperature were obtained.

### Preparation of Toner 1

In a container made of stainless steel (SUS304) having a capacity of 200 mL, 20 parts by mass of polystyrene Hymer ST-120 (weight average molecular weight: 4,000, T₁₀₀=410° C., T_{fb}=72.5° C., T_{q}=89.4° C., T_{η}=81° C., manufactured by Sanyo Chemical Industries, Ltd.) as a binder resin, 18 parts of fine black heat resistant pigment particles made of a Cu—Cr—Mn composite oxide, 42-302A (D₅₀=0.9 μm, manufactured by Tokan Material Technology Co., Ltd.) and 62 parts of bismuth-silica non-lead frit as glass frit having crystallizability (softening point=565° C., crystallization peak temperature=626° C., D₅₀=2 μm) were put and mixed. Then, the mixture was heated to 170° C. and kneaded, and then cooled to room temperature, followed by pulverization and classification to obtain toner matrix particles having D₅₀ of 22.7 μm.

To 100 parts of the toner matrix particles, 0.5 part of fine spherical silica particles AEROSIL R202 (D₅₀=about 14 nm, manufactured by Nippon Aerosil Co., Ltd.) were added, and by means of a tumbler shaker mixer T2F model (manufactured by SHINMARU ENTERPRISES CORPORATION), the fine spherical silica particles were attached to the toner matrix particles to obtain a ceramic color toner having D₅₀ of 22.7 μm (hereinafter referred to as toner 1). Further, AEROSIL R202 was not decomposed at 700° C.

### Preparation of Toner 2

A ceramic color toner having D₅₀ of 13.8 μm (hereinafter referred to as toner 2) was obtained in the same manner as toner 1 except that pulverization and classification were carried out so that D₅₀ became 13.8 μm.

### Example 1

On a glass plate made of soda lime glass (10 cm×10 cm×3.5 mm), by means of an electro printing machine, a first layer made of toner 1 is printed in a rectangular print pattern of 37 mm×20 mm. The thickness of the first layer is 21.9 μm.

Then, by means of an electro printing machine, on this first layer, a second layer made of toner 2 is printed in a rectangular print pattern of 37 mm×20 mm, to obtain a glass plate provided with a laminate. The thickness of the second layer is 15.0 μm.

The glass plate provided with a laminate thus obtained, is baked at 700° C. for 4 minutes to obtain a glass plate provided with a ceramic color print. The thickness of the ceramic color print is 12.3 μm.

### Example 2

On a glass plate made of soda lime glass (10 cm×10 cm×3.5 mm), by means of an electro printing machine, a second layer made of toner 2 is printed in a rectangular print pattern of 37 mm×20 mm. The thickness of the second layer is 15.0 μm.

Then, by means of an electro printing machine, on this second layer, a first layer made of toner 1 is printed in a rectangular print pattern of 37 mm×20 mm to obtain a glass plate provided with a laminate. The thickness of the first layer is 21.9 μm.

The glass plate provided with a laminate thus obtained, is baked at 700° C. for 4 minutes to obtain a glass plate provided with a ceramic color print. The thickness of the ceramic color print is 12.3 μm.

### Comparative Example 1

A glass plate provided with a ceramic color print is obtained in the same manner as in Example 1 except that no printing of the second layer is carried out. The thickness of the ceramic color print is 7.3 μm.

### Evaluation Methods and Evaluation Results

With respect to each glass plate provided with a ceramic color print thus obtained, evaluation of the color difference, adhesion and release property are carried out by the following methods. The evaluation results are shown in Table 1.

TABLE 1

| | | | Release |
|---|---|---|---|
| | Color difference ΔE | Adhesion | property |
| Ex. 1 | 0.64 | ◯ | Acceptable |
| Ex. 2 | 0.26 | ◯ | Acceptable |
| Comp. Ex. 1 | 1.10 | ◯ | Acceptable |

From Table 1, it is evident that in Examples 1 and 2, the adhesion between the ceramic color print and the surface of the glass plate is good, and at the same time, the color difference ΔE is distinctly low.

### Color Difference ΔE

By means of a spectrophotometer, the color tone, as seen from the non-printed surface (the surface on the side on which no ceramic color print is formed), of the pattern-formed region of the glass plate provided with the ceramic color print, was measured, and the color difference ΔE from the standard color (L*=25.27, a*=−0.47, b*=−0.66) was obtained.

### Adhesion

By means of an optical microscope, the pattern-formed region of the glass plate provided with a ceramic color print was observed from the non-printed surface, and the presence or absence of separation, or adhesion failure of the ceramic color print was confirmed.

Here, the adhesion failure means such a state that the ceramic color print does not adhere to the surface of the glass plate but is floating. The evaluation was made based on the following standards. ◯: 5 or less adhesion failures with a diameter of at most 0.5 mm were observed; Δ: at least 6 adhesion failures with a diameter of at most 0.5 mm were observed, or an adhesion failure with a diameter exceeding 0.5 mm was observed, but no separation of the ceramic color print was observed; and X: separation of the ceramic color print was observed.

### Release Property

The glass plate provided with a ceramic color print was inserted between a convex press die and a concave press die each having a glass cloth lined on the surface facing to the other die and maintained to be 670° C. A weight of 10 kg was placed on the convex press die, and pressing was carried out for 5 minutes. Then, the weight and the convex press die were removed, and the presence or absence of attachment of the ceramic color print to the surface of the glass cloth of the convex press die was confirmed. Here, one having no attachment of the ceramic color print was judged to be “acceptable”, and one having such attachment was judged to be “not-acceptable”.

The entire disclosure of Japanese Patent Application No. 2007-315014 filed on Dec. 5, 2007 including specification, claims, drawings and summary is incorporated herein by reference in its entirety.

What is claimed is:

1. A process for producing a glass plate provided with a ceramic color print, wherein a ceramic color print is formed on a glass plate, which comprises a step of forming a laminate having first and second layers laminated by printing on a glass plate, and a step of baking the glass plate having the laminate formed thereon, wherein the first layer is formed by electro printing by using a first ceramic color toner, the second layer is formed by electro printing by using a second ceramic color toner, and the first ceramic color toner has a number average particle size D₅₀ which is larger than D₅₀ of the second ceramic color toner.

2. The process for producing a glass plate provided with a ceramic color print according to claim 1, wherein D₅₀ of the first ceramic color toner is from 10 to 50 μm, and D₅₀ of the second ceramic color toner is from 5 to 20 μm.

3. The process for producing a glass plate provided with a ceramic color print according to claim 1, wherein the first layer has a layer thickness of from 20 to 80 μm, and the second layer thickness of from 5 to 40 μm.

4. The process for producing a glass plate provided with a ceramic color print according to claim 1, wherein the first and second layers are laminated sequentially from the glass plate side.

5. The process for producing a glass plate provided with a ceramic color print according to claim 1, wherein the second ceramic color toner contains glass frit having crystallizability.

6. The process for producing a glass plate provided with a ceramic color print according to claim 4, wherein the second ceramic color toner contains glass frit having crystallizability.

7. The process for producing a glass plate provided with a ceramic color print according to claim 6, wherein crystals are precipitated in the glass frit by heating at a predetermined temperature.

8. The process for producing a glass plate provided with a ceramic color print according to claim 1, wherein the second and first layers are laminated sequentially from the glass plate side.

9. The process for producing a glass plate provided with a ceramic color print according to claim 1, wherein the first ceramic color toner contains glass frit having crystallizability.

10. The process for producing a glass plate provided with a ceramic color print according to claim 8, wherein the first ceramic color toner contains glass frit having crystallizability.

11. The process for producing a glass plate provided with a ceramic color print according to claim 10, wherein crystals are precipitated in the glass frit by heating at a predetermined temperature.

12. The process for producing a glass plate provided with a ceramic color print according to claim 1, which comprises a first step of forming on a photoreceptor a laminate having the first and second layers laminated by printing in an inverse order to the laminate to be formed on the glass plate, and a second step of transferring the laminate formed on the photoreceptor onto the glass plate.

13. The process for producing a glass plate provided with a ceramic color print according to claim 1, which comprises a first step of forming on an intermediate transfer member a laminate having the first and second layers laminated by printing in an inverse order to the laminate to be formed on the glass plate, and a second step of transferring the laminate formed on the intermediate transfer member onto the glass plate, wherein the first step comprises a step of forming the first layer on a photoreceptor, a step of transferring the first layer formed on the photoreceptor onto the intermediate transfer member, a step of forming the second layer on a photoreceptor, and a step of transferring the second layer formed on the photoreceptor onto the intermediate transfer member.
